(19) United States
(12) Patent Application Publication
(10) Pub. No.: US 2012/0285021 A1
(43) Pub. Date: Nov. 15, 2012

(54) NON-ELECTRIC NOSE HAIR CLIPPER

(76) Inventors: Ho Jong Park, Pusan (KR); Eun Ju Dong, Anyang (KR)

(21) Appl. No.: 13/574,749

(22) PCT Filed: Jan. 22, 2011
(86) PCT No.: PCT/KR2011/000426

§ 371 Date: Jul. 23, 2012

(30) Foreign Application Priority Data
Jan. 26, 2010 (KR) 10-2010-0007060
Dec. 13, 2010 (KR) 10-2010-0127230
Jan. 19, 2011 (KR) 10-2011-0005417

(51) Int. Cl. B26B 19/00

(52) U.S. Cl. 30/29.5

(57) ABSTRACT

A non-electric nose hair clipper comprises a first cutting member comprising a first handle part for grip, a circular cutting ring part formed at one end portion of the first handle part and a first coupling part formed at the other end portion of the handle part opposite the cutting ring part; and a second cutting member comprising a second handle part for grip, a cutting plate part formed at one end portion of the second handle part and a second coupling part formed at the other end portion of the second handle part opposite the cutting plate part, wherein the first coupling part of the first cutting member and the second coupling part of the second cutting member are joined to each other by welding, and the circular cutting ring part and cutting plate part are formed such that they meet inclined relative to each other with a predetermined angle defined between them as seen in a lateral sectional view, and the cutting plate part is formed such that its thickness becomes smaller in the direction away from the second coupling part as seen in a lateral sectional view, and wherein the cutting plate part is of circular arc shape on the whole as seen in a front view since bottom of its inner surface is linearly formed, and therefore, when the cutting plate part is inserted in the cutting ring part, a space is formed between the bottom of the cutting plate part and the cutting ring part.

### BACKGROUND OF THE INVENTION

The present invention relates to a non-electric nose hair clipper and a method for manufacturing the same, more particularly, a non-electric nose hair clipper which can reduce the proportion of inferior products while enhancing the accuracy of cutting of the nose hairs and in addition can simplify the manufacturing process.

In case of the nose hairs among various types of hairs growing in the human body, mostly the person himself directly trims his nose hairs, rather than has his nose hairs cut by other person.

Conventionally, devices developed for cutting the nose hairs are mainly classified into two types associated with the way of cutting the nose hairs; one type wherein cutting blades are rotated to cut the nose hairs by running a motor with electric power supplied from a battery and the other type wherein the nose hairs are cut using small scissors.

By the way, the device for cutting the nose hairs using the battery and motor has problems that its use is troublesome due to frequent failure and replacement of the battery and since the nose hairs grow in irregular direction, not in a constant direction by nature it is difficult to efficiently cut the nose hairs.

Furthermore, due to unique vibration generated from the motor driven for rotating the cutting blades, sneeze and snivel are caused, which cause the user to be uncomfortable.

In such a course, the snivel and nose hairs may enter the electric nose hair cutting device, which phenomenon may cause the propagation of various germs and lead to human infection at the slightest slip.

Meanwhile, in the case of a nose hair clipper of small scissors type by nature, it may cause the user to be anxious what if his nose is cut by the user himself, thus, in order to avoid such a situation, the user commonly cuts his nose hairs while viewing the inside of his own nostril using small mirror.

Therefore, the user has to be very careful in scissoring, and if not careful, injure may caused in the nostril, which injure may be a cause of infection with various germs.

### SUMMARY OF THE INVENTION

The present invention has been devised to solve the above-mentioned problems, and its object is to provide a nose hair clipper which can increase efficiency of cutting of the nose hairs, and method for manufacturing such a nose hair clipper.

Another object of the present invention is to provide a nose hair clipper which can epochally lower the difficulty of the whole manufacturing process, and method for manufacturing such a nose hair clipper.

Yet another object of the present invention is to provide a nose hair clipper which can effectively cut the nose hairs even when several nose hairs are simultaneously inserted, and method for manufacturing the nose hair clipper.

Yet another object of the present invention is to provide a nose hair clipper which can reduce operational error associated with a manner of operating even when the manner of operating of the nose hair clipper is different for individual user of the nose hair clipper, and method for manufacturing such a nose hair clipper.

Yet another object of the present invention is to provide a nose hair clipper which can remarkably reduce the proportion of inferior products that may be produced in the manufacturing process of nose hair clipper, and method for manufacturing such a nose hair clipper.

Yet another object of the present invention is to provide a nose hair clipper which allows easy engagement of cutting ring part with cutting plate part, and method for manufacturing such a nose hair clipper.

Yet another object of the present invention is to provide a nose hair clipper which can ensure excellent positional precision even by automated manufacturing process, and method for manufacturing such a nose hair clipper.

A non-electric nose hair clipper according to the present invention for achieving the above-mentioned objects comprises a first cutting member comprising a first handle part for grip, a circular cutting ring part formed at one end portion of the first handle part and a first coupling part formed at the other end portion of the handle part opposite the cutting ring part; and a second cutting member comprising a second handle part for grip, a cutting plate part formed at one end portion of the second handle part and a second coupling part formed at the other end portion of the second handle part opposite the cutting plate part, wherein the first coupling part of the first cutting member and the second coupling part of the second cutting member are joined to each other by welding, and the circular cutting ring part and cutting plate part are formed such that they meet inclined relative to each other with a predetermined angle defined between them as seen in a lateral sectional view, and the cutting plate part is formed such that its thickness becomes smaller in the direction away from the second coupling part as seen in a lateral sectional view, and wherein the cutting plate part is of circular arc shape on the whole as seen in a front view since bottom of its inner surface is linearly formed, and therefore, when the cutting plate part is inserted in the cutting ring part, a space is formed between the bottom of the cutting plate part and the cutting ring part.

Herein, inner surface of the cutting ring part and inner surface of the cutting plate part may be polished.

Preferably, the first and second cutting members are all formed using metal plate, and the outer surfaces of the first and second handle parts contacted with user's fingers comprise linear areas parallel to each other within a range of manufacturing tolerance as seen in a lateral section.

Preferably, the linear area in the portions of maximum width of the first and second handle parts has a width of from 3 mm to 2 cm.

Preferably, the linear area in the portions of maximum width of the first and second handle parts has a width of from 5 mm to 1.5 cm.

Preferably, the thickness of portions of maximum thickness of the first and second handle parts ranges from 0.1 mm to 2 mm.

Preferably, a nearly vertical projection is formed between inner surface of the second handle part and inner surface of the cutting plate part within a range of manufacturing tolerance.

Preferably, formed in the first and second handle parts are grip guiding portions for guiding the contact of user's fingers.

Meanwhile, a method for manufacturing a non-electric nose hair clipper according to the present invention comprises a step of forming a first cutting member in one piece using metal plate, which first cutting member comprises a first handle part for grip, a cutting ring part formed at one end portion of the first handle part and a first coupling part formed at the other end portion of the first handle part opposite the cutting ring part; a step of forming a second cutting member in one piece using the metal plate, which second cutting member comprises a second handle part for grip, a cutting plate part formed at one end portion of the second handle part and a second coupling part formed at the other end portion of the second handle part opposite the cutting plate part; a step of joining the first coupling part and second coupling part by welding; and a step of polishing the cutting ring part and cutting plate part.

Preferably, the cutting ring part and cutting plate part are simultaneously polished using a polishing wheel which has a horizontal lower surface and a slanted upper surface.

Herein, the method may further comprise a step of removing burrs formed on the first and second cutting members following the step of forming the first cutting member in one piece using the metal plate and the step of forming the second cutting member in one piece using the metal plate

Preferably, the step of removing burrs is performed utilizing vibration barrel.

According to the present invention, efficiency of cutting of the nose hairs can be increased.

Furthermore, the difficulty of the whole manufacturing process can be epocally lowered.

Furthermore, even when several nose hairs are simultaneously inserted, the several nose hairs can be effectively cut.

Furthermore, operational error associated with a manner of operating can be reduced even when the manner of operating of the nose hair clipper is different for individual user of the nose hair clipper.

Furthermore, the proportion of inferior products that may be produced in the manufacturing process of nose hair clipper can be remarkably reduced.

Furthermore, easy engagement of cutting ring part with cutting plate part is allowed.

Furthermore, excellent positional precision can be ensured even by automated manufacturing process.

### BRIEF DESCRIPTION OF THE DRAWINGS

FIG. 1 is a perspective view a nose hair clipper according to the present invention.

FIG. 2 is a front view illustrating inner surface of first and second cutting members of the nose hair clipper according to the present invention.

FIG. 3 is a lateral view of the nose hair clipper according to the present invention.

FIG. 4 is a lateral view illustrating initial state of engagement of a first cutting member with a second cutting member.

FIG. 5 is a front view illustrating the processing of the second cutting member.

FIG. 6 is a perspective view of a non-electric nose hair clipper according to one example of the present invention.

FIG. 7 is a perspective view of a non-electric nose hair clipper according to one example of the present invention.

FIG. 8 is, a front view of a non-electric nose hair clipper according to one example of the present invention.

FIG. 9 is a view illustrating simultaneous polishing of a cutting ring part and cutting plate part according to a method of the present invention.

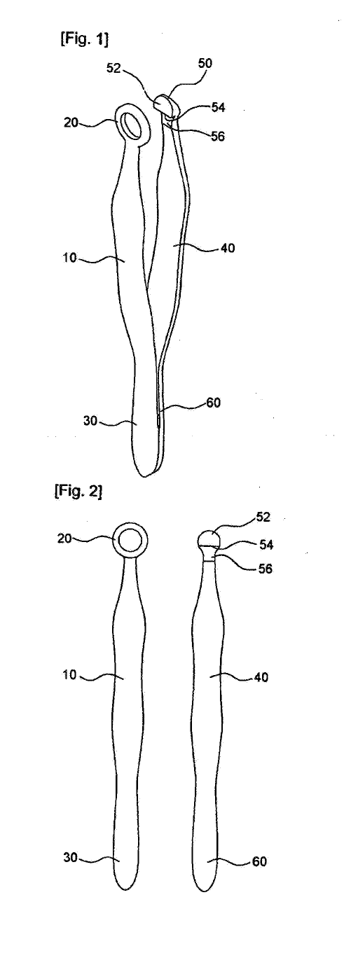

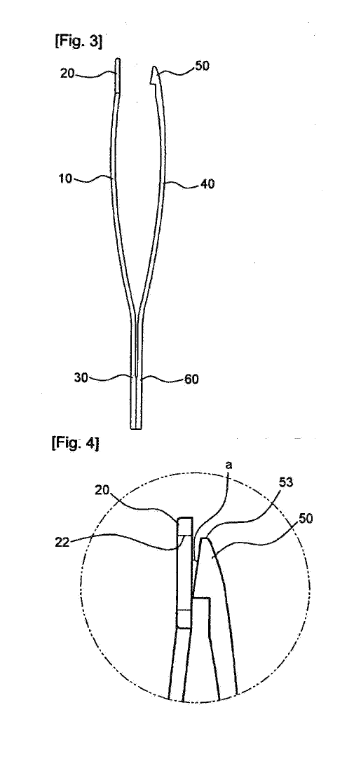

### DETAILED DESCRIPTION OF THE INVENTION

Hereinafter, the construction of the present invention will be described in detail with reference to the attached drawings.

Prior to detailed description, it should be noted that terms used in the specification and claims should not be limitedly interpreted as normal or lexical meanings, but should be interpreted as meanings and concepts coinciding to technical concepts of the present invention based on the principle that inventors may properly define the concepts of the terms in order to explain their inventions in a best way.

Therefore, examples described in the specification and constructions illustrated in the drawings are only most preferred example of the present invention, and do not represent all of the technical concepts of the present invention, and thus it should be understood that various equalities and modifications may be present which can replace them at the time of application of the present invention.

A non-electric nose hair clipper according to the present invention comprises a first cutting member comprising a first handle part (10) for grip, a circular cutting ring part (20) formed at one end portion of the first handle part (10) and a first coupling part (30) formed at the other end portion of the handle part (10) opposite the cutting ring part (20); and a second cutting member comprising a second handle part (40) for grip, a cutting plate part (50) formed at one end portion of the second handle part (40) and a second coupling part (60) formed at the other end portion of the second handle part (40) opposite the cutting plate part (50). The first coupling part (30) of the first cutting member and the second coupling part (60) of the second cutting member are joined to each other by welding, and the circular cutting ring part (20) and cutting plate part (50) are formed such that they meet inclined relative to each other with a predetermined angle defined therebetween as seen in a lateral sectional view. The cutting plate part (50) is formed such that its thickness becomes smaller in the direction away from the second coupling part (60) as seen in a lateral sectional view. The cutting plate part (50) is of circular arc shape on the whole as seen in a front view since bottom of its inner surface (52) is linearly formed, and therefore, when the cutting plate part (50) is inserted in the cutting ring part (20), a space (s) is formed between the bottom of the cutting plate part (50) and the cutting ring part (20).

The first handle part (10) and second handle part (40) are parts intended to be griped by thumb or index finger of user, and are preferably linear or gently curved as seen in a lateral sectional view.

The cutting ring part (20) is of circular ring shape on the whole and constructed such that skin inside the nostril is not injured at the time of cutting the nose hairs even when the user inadvertently uses the nose hair clipper.

The first coupling part (30) is a part intended to be joined with the second coupling part (60), and is formed in the shape of straight line of a predetermined length as seen in a lateral sectional view.

Herein, the first handle part (10), cutting ring part (20) and first coupling part (30) are integrally formed by first obtaining the whole shape using metal wire or metal plate and thereafter drilling the cutting ring part (20).

Alternatively, the first cutting member may be formed in one piece by processing the metal plate at a time including obtaining of the shape of drilled ring of the cutting ring part (20) and then removing burr formed on outer surface.

The cutting ring part (50) is inserted in inner circular opening of the cutting ring part (20) to cut the nose hairs.

The second cutting member is also formed by first processing the metal wire or metal plate into the whole shape of the second cutting member and then polishing the inner surface (52) of the cutting, plate part (50).

The first and second coupling parts (30, 60) are formed in the shape of straight line of predetermined length as seen in a lateral sectional view and joined to each other by spot welding.

In one embodiment of the present invention, the first and second cutting members are each separately formed as a discrete member, and finally the first and second coupling parts (30, 60) are joined to each other by the spot welding, whereby the nose hair clipper according to the present invention is formed.

Thus, when compared to adjusting positions of the first and second cutting members by bending, the two members can be fixed to each other even with automated process by more precisely adjusting the relative positions of the cutting ring part (20) and cutting plate part (50) so that the two parts can be correctly engaged with each other.

Furthermore, since the first and second coupling parts (30, 60) are joined to each while formed in the shape of line of predetermined length as described above, sufficient joining strength between the two parts can be ensured.

Therefore, even after a long period of use by the user, the relative position between the cutting ring part (20) and cutting plate part (50) is not disturbed.

Herein, the first and second coupling parts (30, 60) are constructed such that they are joined to each other by the spot welding to have sufficient joining strength.

Hence, the first and second coupling parts (30, 60) can be joined with automated process while ensuring a sufficient joining strength between the two parts.

Furthermore, the first and second coupling parts (30, 60) can be joined by the spot welding without leaving any traces of welding on outer surfaces of the first and second cutting members.

Meanwhile, as illustrated in FIG. 4, plane of the circular cutting ring part (20) and plane of the cutting plate part (50) are formed such that the two planes meet inclined relative to each other with a predetermined angle(a) defined therebetween as seen in a lateral sectional view.

Therefore, when the cutting plate part (50) is inserted in the cutting ring part (20) to cut the nose hairs, surface of the cutting plate part (50) and surface of the cutting ring part (20) are sequentially contacted, whereby an effect is exhibited of scissors wherein its two blades are sequentially contacted to cut an object.

In the case of conventional non-electric nose hair clipper, if a plurality of nose hairs are caught between the cutting ring and cutting plate at a time, a case is shown that the nose hairs cannot be cut due to their resistances, but in the case of the nose hair clipper according to the present invention, such a phenomenon is prevented by the construction as described above.

Namely, even when a plurality Of nose hairs are caught between the cutting ring part (20) and cutting plate part (50) according to the present invention, the cutting ring part (20) and cutting plate part (50) sequentially contact with and press the plurality of nose hairs like scissors as described above, whereby unlike non-electric nose hair clipper according to prior art, the cutting ring part and cutting plate part do not contact with and press all nose hairs at a time.

Therefore, in the case of the non-electric nose hair clipper according to prior art, a case occurs that all nose hairs are contacted and pressed at a time, but in the case of the nose hair clipper according to the present invention, each nose hair is individually sequentially pressed and cut.

Therefore, power or efficiency of cutting of the nose hairs can be increased.

Meanwhile, the cutting plate part (50) is constructed such that its thickness becomes smaller in the direction away from the second coupling part (60) as seen in a lateral sectional view.

Therefore, the thickest portion of cutting plate part (50) positioned close to the second coupling part (60) first enters the cutting ring part (20), and thereafter outer circumferential surface of the cutting plate part (50) is contacted and guided by the inner circumferential surface of the cutting ring part (20), and the entire cutting plate part (50) is guided to enter the cutting ring part (20).

Herein, by making the thickness of outer circumferential surface (53) of the cutting plate part (50) small, the outer circumferential surface (53) can be prevented from interfering with the inner circumferential surface (22) of the cutting ring part (20).

The nose hairs are thin, so in order to smoothly cut the nose hairs, very precise plane contact has to be ensured between the inner circumferential surface (22) of the cutting ring part (20) and outer circumferential surface (53) of the cutting plate part (50).

When the second cutting member is operated, the outer circumferential surface (53) of the cutting plate part (50) is rotated with a constant radius relative to the second coupling part (60) since the second coupling part (60) is in a fixed state.

Therefore, if the outer circumferential surface (53) of the cutting plate part (50) is thick, each point on the outer circumferential surface (53) of the cutting plate part (50) is rotated with respective different radius relative to a fixed position of the second coupling part (60).

Therefore, in order to form a very fine gap between the cutting ring part (20) and cutting plate part (50) while allowing the cutting plate part to smoothly enter the cutting ring part, a very precise processing is required, thus if the outer circumferential surface (53) of the cutting plate part (50) is thick, such a processing becomes very difficult.

Therefore, by reducing the thickness of outer end portion of the cutting plate part (50), the outer end portion of the cutting plate part (50) can have nearly constant rotational radius relative to the fixed position of the second coupling part (60).

Thus, it is possible to more easily implement a process for forming the very narrow gap between the cutting ring part (20) and cutting plate part (50) very small while allowing the cutting plate part to smoothly enter the cutting ring part.

Meanwhile, as illustrated in FIG. 2, the cutting plate part (50) is of circular arc shape on the whole since the bottom of its inner surface (52) is linearly formed.

Thus, when the cutting plate part (50) is inserted in the cutting ring part (20), a space (s) is formed between the cutting plate part and cutting ring part, as illustrated in FIG. 8.

When the cutting plate part (50) is inserted in the nostril of the human body, upper and side portions of the cutting plate part (50) are mainly used for cutting the nose hairs, and effect of the lowest portion of cutting plate part (50) on the cutting of the nose hairs is insignificant.

Herein, in order for the cutting plate part (50) to easily enter the cutting ring part (20), it is preferable to eliminate lower portion of the inner surface (52) of the cutting plate part (50).

In course of research and development by the applicant, it was found that if the inner surface of the cutting plate part (50) is of circular shape on the whole rather than circular arc shape, in order to cut the nose hairs while allowing the cutting plate part (50) to enter the cutting ring part (20) to reach the inner circumferential surface (22) thereof, manufacturing precision has to be very high (the range of manufacturing tolerance has to be very narrow).

Such a factor makes it difficult to manufacture the cutting plate part (50) and also drastically increases the proportion of inferior products in the manufacturing, and a case occurs that even though the cutting plate part (50) enters the cutting ring part (20) to reach the inner circumferential surface (22) thereof the nose hairs are caught between the cutting plate part and cutting ring part or cannot be smoothly cut.

Therefore, difficulty of the process for enabling the nose hairs to be cut without impossibility while allowing the cutting plate part (50) to smoothly enter the cutting ring part (20) became a cause of it being not possible to manufacture and sell products in reality.

According to a search conducted for a long time in order to solve such a problem, it was found that the problem can be solved by eliminating the lower portion of the inner surface (52) of the cutting plate part (50).

This is because it is the upper and side portions of the cutting plate part (50) and cutting ring part (20) that are used for actually cutting the nose hairs and effect of the lowest portion thereof on the cutting of the nose hairs is insignificant.

A portion making it particularly difficult to process the cutting plate part (50) in the shape of circle on the whole is a boundary portion where the cutting plate part (50) and upper portion (56) of the second handle part (40) meet; by eliminating the lower portion of the inner surface of the cutting plate part (50) and forming a linear boundary portion (54), the remaining circular arc portion cuts the nose hairs, hence the difficulty of the manufacturing is solved.

Thus, by preventing the lower portion of inner surface (52) of the cutting plate part (50) and lower portion of inner surface of the cutting ring part (20) from interfering with each other, the cutting plate part (50) can be rotated about the second coupling part (60) to enter the cutting ring part (20) to a certain depth without interference.

In order to prevent the lower portion of inner surface (52) of the cutting plate part (50) and lower portion of inner surface of the cutting ring part (20) from interfering with each other as mentioned above, a nearly vertical projection is formed between upper inner surface (56) of the second handle part (40) and inner surface (52) of the cutting plate part (50) within a range of manufacturing tolerance.

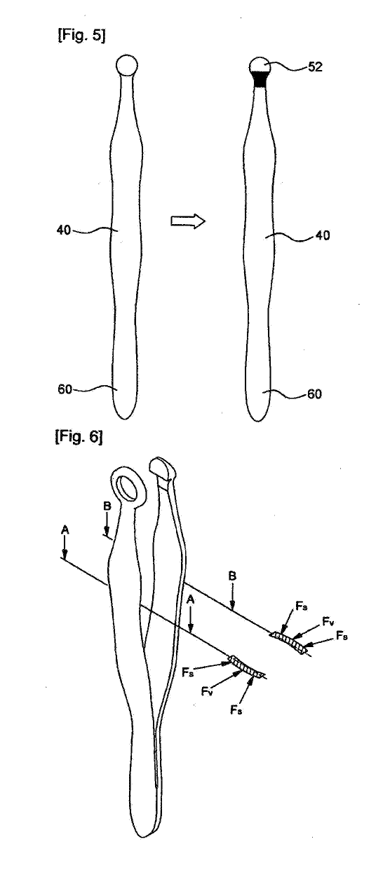

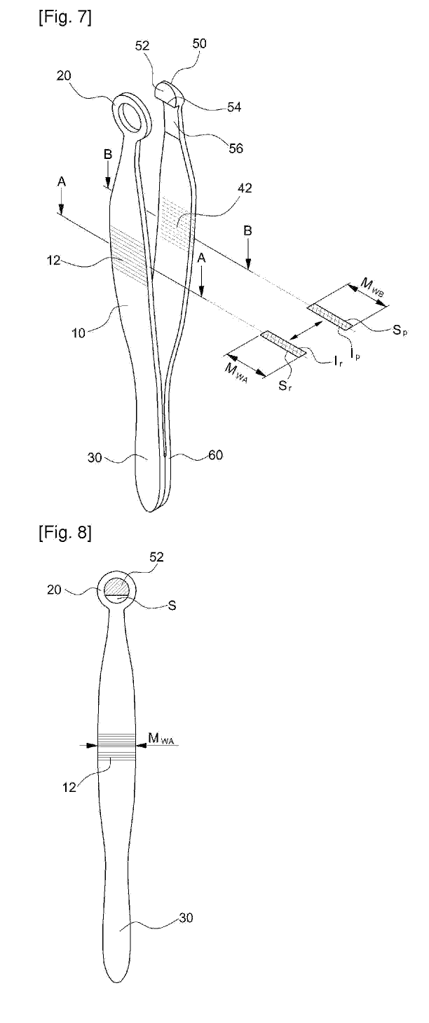

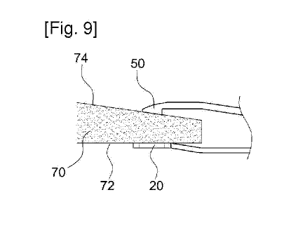

In order to eliminate the lower portion of the inner surface (52) of the cutting plate part (50) as mentioned above, the projection is formed at the boundary part (54) between the upper portion (56) of the second handle part and cutting plate part (50) by means of press etc., or as illustrated in FIG. 5, the cutting plate part (50) is first formed in a circular shape, and subsequently the lower portion of the cutting plate part (50) may be cut to form the linear boundary portion (54).

Furthermore, the inner surfaces of the cutting plate part (50) and cutting ring part (20) are polished, and the inner circumferential surface (22) of the cutting ring part (20) and outer circumferential surface (53) of the cutting plate part (50) are processed so as to be perpendicular to the inner surface of the cutting ring part (20) and inner surface (52) of the cutting plate part, respectively, whereby final precise finish for allowing more easy cutting of the nose hairs is completed.

The applicant of the present invention has known that if the first and second cutting members are all processed using the metal wire, the outer surfaces of the first and second handle parts are formed to have a shape close to a curved surface.

By the way, if the first and second cutting members are formed to have outer surface of curved surface shape using metal wire as described above, high class maybe imparted in terms of the design of entire external appearance, but a case occurs that the cutting plate part does not smoothly enter the cutting ring part depending on a manner of operating of the user.

That is, referring to FIG. 6, since the outer surfaces of the handle parts have a cross section of curved line shape, frequency of case (Fs) that forces transmitted from fingers of the user are applied to side portions of the handle parts is higher than that of case (Fv) that the forces are applied to the handle parts accurately perpendicular thereto.

It is because frequency of case (Fs) of applying the forces in the directions allowing the cutting ring part and cutting plate part to meet each other while gripping portions of the handle parts other than central portions thereof is higher than that of case (Fv) of applying the forces in the directions allowing the cutting ring part and cutting plate part to meet each other while gripping accurate central portions thereof, depending on the users.

If the forces are applied to portions of the handle parts slightly offset from the central portions thereof as described above, the handle parts cannot move to a position where the centers of the cutting ring part and cutting plate part accurately coincide with each other due to curved cross-sectional shape of the, handle parts.

If the handle parts move to a position where the centers of the cutting ring part and cutting plate part do not accurately coincide with each other depending on a manner of operating of the user as described above, the gap between the cutting ring part and cutting plate part is minutely varied along the circumferential direction of the cutting ring part, and such a phenomenon may cause cutting failure or catching of the nose hairs.

Furthermore, also in the case that slight manufacturing error is generated in the manufacturing process, the cutting plate part may not smoothly enter the cutting ring part, thus a function of cutting the nose hairs may not be exhibited.

Therefore, according to one embodiment of the present invention, the first and second handle parts (10, 40) is constructed to have a cross section of rectangular shape so that operating forces may applied to the first and second handle parts (10, 40) perpendicular thereto even in the case of manners of operating of the users being different for each user when the first and second handle parts (10, 40), are operated using the thumb and index finger.

In order for the first and second handle parts (10, 40) to have the cross section of rectangular shape as described above, the first and second cutting members are formed using metal plate.

Therefore, outer surfaces (Sp, Sr) of the first and second handle parts (10, 40) contacted with the user's fingers are formed parallel to each other within the range of manufacturing tolerance.

Herein, it is preferred that linear area in portions (M_{WA}, M_{WB}) of maximum width of the first and second handle parts (10, 40) has a width of at least 3 mm.

If the linear area in the portions of maximum width has a width of less than 3 mm, the forces transmitted from the user's fingers may be applied to edges of the handle parts (10, 40), thus a component of the forces may be generated which causes the two handle parts (10, 40) to move in directions other than the directions allowing the handle parts to move toward each other.

In such a case, the cutting plate part (50) may not smoothly enter the cutting ring part (20).

Furthermore, the linear area in the portions (M_{WA}, M_{WB}) of maximum width of the first and second handle parts (10, 40) has a width of 2 cm or less.

If the linear area has a width of more than 2 cm, the amount and weight of the entire metal plate are increased, and excessive force is required for operation by the user.

For the above reason, more preferably, the linear area in the portions of maximum width of the first and second handle parts has a width of from 5 mm to 1.5 cm.

Furthermore, the thickness of portions of maximum thickness of the first and second handle parts (10, 40) ranges from 0.1 mm to 2 mm.

If the thickness is less than 0.1 mm, the handle parts (10, 40) may be easily deformed, in which case the cutting plate part (50) may not smoothly enter the cutting ring part (20) due to deformation resulting from operation of a long time.

If the thickness exceeds 2 mm, the amount and weight of the entire metal plate are increased, and excessive force is required for operation by the user.

Meanwhile; in the first and second handle parts (10, 40), the outer surfaces (Sr, Sp) contacted with the user's fingers and inner surface (Ir, Ip) having no contact with the user's fingers include linear areas parallel to each other as seen in a lateral sectional view.

Therefore, if operating force of the user is applied to the first and second handle parts (10, 40), the two handle parts are displaced toward each other.

For the same reason as mentioned above, the linear areas parallel to each other as seen in a cross-sectional view are also formed with a width of from 3 mm to 2 cm, more preferably, from 5 mm to 1.5 cm.

For the same reason as mentioned above, formed in the first and second handle parts (10, 40) are grip guiding portions (12, 42) for guiding the contact of user's fingers.

The user is guided by the grip guiding portion (12, 42) to apply the operating force while bring the fingers into contact with the grip guiding portions (12, 42), thus the cutting plate part (50) can smoothly and more accurately enter the cutting ring part (20).

Meanwhile, a method for manufacturing a non-electric nose hair clipper according to one example of the present invention comprises a step of forming the first cutting member in one piece using the metal plate, which first cutting member comprises the first handle part (10) for grip, the cutting ring part (20) formed at one end portion of the first handle part (10) and the first coupling part (30) formed at the other end portion of the first handle part (10) opposite the cutting ring part (20); a step of forming the second cutting member in one piece using the metal plate, which second cutting member comprises the second handle part (40) for grip, the cutting plate part (50) formed at one end portion of the second handle part (40) and the second coupling part (60) formed at the other end portion of the second handle part (40) opposite the cutting plate part (50); a step of joining the first coupling part (30) and second coupling part (60) by welding; and a step of polishing the cutting ring part (20) and cutting plate part (50).

In the manufacturing method according to one example of the present invention, the first cutting member comprising the first handle part (10), cutting ring part (20) formed with a hole and first coupling part (30) is simultaneously formed at a time using the metal plate.

Furthermore, the second cutting member comprising the second handle part (40), cutting plate part (50) and second coupling part (60) is simultaneously formed at a time using the metal plate.

Next, following the step of forming the first cutting member in one piece using the metal plate and the step of forming the second cutting member in one piece using the metal plate, burrs formed on outer surface of each of the first and second cutting members are removed.

Regarding removal of the burrs, the burrs on the outer surface can be removed by processing the first and second cutting members by means of barrel.

In this connection, for imparting a precise dimension to the cutting ring part (20) and cutting plate part (50), it is preferable to process the first and second cutting members by means of vibration barrel, rather than rotational barrel.

It is because the rotational barrel can remove external burrs on the workpiece more rapidly compared to the vibration barrel, but has a slight difference in the rate of removing material of the outer surface of the workpiece for each portion of the rotational barrel

Therefore, by means of the vibration barrel using finer polishing media compared to the rotational barrel, the cutting ring part (20) and cutting plate part (50) can have a precise dimension and glossily polished.

Next, the first and second linear coupling parts (30, 60) of predetermined length are joined to each other by the spot welding.

Herein, for processing the circular cutting ring part (20) and cutting plate part (50) so that the planes of the two parts meet inclined relative to each other with a preset angle seen in a lateral sectional view, the circular cutting ring part (20) and cutting plate part (50) are simultaneously polished using a polishing wheel (70)'which has a horizontal lower surface (72) and a slanted upper surface (74).

Thus, by processing edge portions of the inner surfaces of the cutting ring part (20) and cutting plate part (50) to be nearly right angle, final precise finish more advantageous to the cutting of the nose hairs is implemented.

By simultaneously polishing the cutting ring part (20) and cutting plate part (50) with one polishing wheel (70) after joining the first and second coupling parts to each other by the spot welding as described above, relative positional precision of the cutting ring part (20) and cutting plate part (50) can be enhanced while the whole manufacturing process can be simplified.

For cutting the nose hairs by means of cooperation of the cutting ring part (20) and cutting plate part (50), it is essential to polish the inner surface of the cutting ring part (20) and inner surface of the cutting plate part (50).

By the way, in case where the first and second cutting members are formed respectively and then the inner surfaces of the cutting ring part (20) and cutting plate part (50) are polished respectively and thereafter the first and second coupling part (30, 60) are joined to each other by welding, it was found that there may be a minute discrepancy of the relative position of the cutting ring part (20) and cutting plate part (50) in course of welding, which phenomenon increase the proportion of inferior products in the manufacturing.

Therefore, the applicant has known that for ensuring the relative positional precision of the cutting ring part (20) and cutting plate part (50), it is very preferable to join the first and second coupling part (30, 60) to each other by the spot welding with the cutting plate part (50) inserted in the cutting ring part (20) and then after spacing (spreading) the cutting ring part (20) and cutting plate part (50) from each other, insert the polishing wheel between the cutting ring part (20) and cutting plate part (50) to polish them.

In one example of the present invention, in order to eliminate the lower portion of the inner surface (52) of the cutting plate part (50), the projection (54) is formed between the upper portion (56) of the second handle part (40) and lower portion of the inner surface (52) of the cutting plate part (50) by means of press, and the inner surface (52) of the cutting plate part (50) is polished using the polishing wheel (70), whereby the upper portion (56) of the second handle part and lower portion of the inner surface (52) form right angle relative to each other.

As mentioned above, though the present invention has been described with the specific examples and drawings, its technical concepts are not limited to them, and therefore the persons having ordinary skills in the art may carry out the present invention in other way by various modifications and alterations thereof without departing from the technical concepts of the present invention and equalities of the following claims.

What is claimed is:

1. A non-electric nose hair clipper comprising:
a first cutting member comprising a first handle part for grip, a circular cutting ring part formed at one end portion of the first handle part and a first coupling part formed at the other end portion of the handle part opposite the cutting ring part; and
a second cutting member comprising a second handle part for grip, a cutting plate part formed at one end portion of the second handle part and a second coupling part formed at the other end portion of the second handle part opposite the cutting plate part,
wherein the first coupling part of the first cutting member and the second coupling part of the second cutting member are joined to each other by welding, and the circular cutting ring part and cutting plate part are formed such that they meet inclined relative to each other with a predetermined angle defined therebetween as seen in a lateral sectional view, and the cutting plate part is formed such that its thickness becomes smaller in the direction away from the second coupling part as seen in a lateral sectional view, and
wherein the cutting plate part is of circular arc shape on the whole as seen in a front view since bottom of its inner surface is linearly formed, and therefore, when the cutting plate part is inserted in the cutting ring part, a space is formed between the bottom of the cutting plate part and the cutting ring part.

2. The non-electric nose hair clipper according to claim 1, wherein inner surface of the cutting ring part and inner surface of the cutting plate part are polished.

3. The non-electric nose hair clipper according to claim 1, wherein the first and second cutting members are all formed by shaping of metal plate, and the outer surfaces of the first and second handle parts contacted with user's fingers comprise linear areas parallel to each other within a range of manufacturing tolerance as seen in a lateral section.

4. The non-electric nose hair clipper according to claim 3, wherein the linear area in the portions of maximum width of the first and second handle parts has a width of from 3 mm to 2 cm.

5. The non-electric nose hair clipper according to claim 3, wherein the linear area in the portions of maximum width of the first and second handle parts has a width of from 5 mm to 1.5 cm.

6. The non-electric nose hair clipper according to claim 3, wherein the thickness of portions of maximum thickness of the first and second handle parts ranges from 0.1 mm to 2 mm.

7. The non-electric nose hair clipper according to claim 1, wherein a nearly vertical projection is formed between upper inner surface of the second handle part and inner surface of the cutting plate part within a range of manufacturing tolerance.

8. The non-electric nose hair clipper according to claim 1, wherein formed in the first and second handle parts are grip guiding portions for guiding the contact of user's fingers.

9. A method for manufacturing a non-electric nose hair clipper, comprising:
a step of forming a first cutting member in one piece using metal plate, which first cutting member comprises a first handle part for grip, a cutting ring part formed at one end portion of the first handle part and a first coupling part formed at the other end portion of the first handle part opposite the cutting ring part;
a step of forming a second cutting member in one piece using the metal plate, which second cutting member comprises a second handle part for grip, a cutting plate part formed at one end portion of the second handle part and a second coupling part formed at the other end portion of the second handle part opposite the cutting plate part;
a step of joining the first coupling part and second coupling part by welding; and
a step of polishing the cutting ring part and cutting plate part.

10. The method for manufacturing a non-electric nose hair clipper according to claim 9, wherein the cutting ring part and cutting plate part are simultaneously polished using a polishing wheel which has a horizontal lower surface and a slanted upper surface.

11. The method for manufacturing a non-electric nose hair clipper according to claim 9, further comprising a step of removing burrs formed on the first and second cutting members following the step of forming the first cutting member in one piece using the metal plate and the step of forming the second cutting member in one piece using the metal plate

12. The method for manufacturing a non-electric nose hair clipper according to claim 11, wherein the step of removing burrs is performed utilizing vibration barrel.
